(19) United States
(12) Patent Application Publication
(10) Pub. No.: US 2005/0266178 A1
(43) Pub. Date: Dec. 1, 2005

(54) Method of manufacturing resin film, polarizing plate made of resin film and liquid crystal display device made of polarizing plate

(75) Inventor: Kazuyuki Shimizu, Akashi-shi (JP)

Correspondence Address: FRISHAUF, HOLTZ, GOODMAN & CHICK, PC, 220 5TH AVE FL 16, NEW YORK, NY, 10001-7708, US

(73) Assignee: KONICA MINOLTA OPTO, INC., Tokyo (JP)

(21) Appl. No.: 11/135,529

(22) Filed: May 23, 2005

(30) Foreign Application Priority Data
Jun. 1, 2004 (JP) JP2004-162784

(51) Int. Cl. C09K 19/00

(52) U.S. Cl. 428/1.31; 428/141

(57) ABSTRACT

A method of manufacturing a resin film, including the steps of, a) slitting a resin base at both edge portions, the resin base comprising cellulose acetate or a norbornene type resin so as to form a resin base to a predetermined product width; and b) providing a knurling process on both edges of the slitted resin base, resulting in a final film thickness of 30 to 125 μm, a film thickness deviation in at random points across the width of 0.1 to 1.8 μm, and a creak value of 0.4 to 1.4, wherein a mean value of knurling knob height measured at 10 random points is 5 to 15 μm, a minimum value of measured knurling knob height is more than 1 μm, a maximum value of measured knurling knob height is less than 20 μm, and a deviation of the measured knurling knob height is 1 to 10 μm.

This application is based on Japanese Patent Application No. 2004-162784 filed on Jun. 1, 2004, in Japanese Patent Office, the entire content of which is hereby incorporated by reference.

### FIELD OF THE INVENTION

The present invention relates to a method of manufacturing of a cellulose ester or a norbornene type resin film which is suitable as a protective film of a polarizing plate in a liquid crystal display device (LCD), a polarizing plate prepared by utilizing the resin film, and a liquid crystal display device prepared by utilizing the polarizing plate.

### BACKGROUND

In recent years, in accordance with utilization of a liquid crystal display (LCD) in various applications, high productivity has been required also with respect to a liquid crystal display element utilized for LCDs, that is, a polarizing plate. In addition to this, since liquid crystal display devices have become thinner and thinner, a polarizing plate utilized in LCD is also required to be thinner.

Presently, a cellulose triacetate (TAC) film is employed as a protective film for a polarizing plate of LCD, however, the effort for quality of a cellulose ester film increases when such high productivity of a cellulose ester film is achieved, in conjunction with a higher productivity of a polarizing plate.

Heretofore, in a method to manufacture a cellulose ester film by a solution casting method, a dope which is a raw material solution of a cellulose ester film, is flowed by a casting die on a metal loop belt or a metal rotating drum (being as a support), the web is transported by conveyance rollers, the edges of which are provided with limiting power, after the web is peeled from the support; the web is laterally stretched by a tenter system before or after roll conveyance and dried, after which it is wound onto a core by a winder; resulting in preparation of a roll of cellulose ester film.

Herein, when a thin film of 25-100 μm is wound up as a roll and stored, “an offset of uneven thickness” also called “a black band” may be generated on the core side at the center portion. In the case of optimal quality required of a film such as in optical applications, variation of optical properties due to this black band may become a major problem.

In other words, when a length at the center portion of a film is less than at the edges of the film, the film may exhibits a “flute” state. Since the center portion tends to be wound tighter when such a film is wound, the center portion adheres to adjacent surfaces to cause a “black band”. When such a film is rewound during production, deformation as knicks is caused at the time of peeling the film having adhered portions. When a polarizing plate is prepared by utilizing a film having such deformation, a uniform polarizing degree cannot be obtained because the polarizing degree in the vicinity of the deformation is different from that in other portions. Therefore, a liquid crystal display device prepared by utilizing such a polarizing plate is unable to present a uniform display, and is unviable as a commercial product.

To overcome these problems, well known is a method which can prevent winding slippage and winding looseness by winding the film around a core, provided with knurling of a predetermined thickness (being a minute roughness, also called as embossing or a knurling treatment) on both edges of the cellulose ester film (web) to make both edges of the film slightly thicker and the center portion slightly thinner.

Herein, patent literature concerning knurling of a cellulose ester utilized for a conventional protective film of a polarizing plate is as follows.

Patent Literature 1: JP-A No. 2002-187148 (hereinafter, JP-A refers to an Unexamined Japanese Patent Application Publication)

In Patent Literature 1, disclosed is a cellulose ester film manufactured by a solution casting method, wherein the difference between the longest and the shortest length, in the width direction, is not more than 0.05% of the length of the shortest portion in the width direction, the difference of the length of both edges of the film is not more than 0.03% of the length of the shorter edge portion of a film; the difference between the mean film thickness in the longitudinal direction at the knurled portion and the mean film thickness of the other potions is 3-25 μm; and further, the difference between the mean thickness in the longitudinal direction at both edge knurled portions is not more than 5 μm.

According to patent literature 1, generation of knicks and weaving (being winding slippage) due to poor roll formation (generation of a black band and a depression) can be prevented when a cellulose triacetate film, which is suitable for such a protective layer of a polarizing plate, is wound up on a core.

Patent Literature 2: JP-A No. 2002-211803

In Patent Literature 2, disclosed is a film roll in which a film provided with knurling at the edge portions is wound on a core, wherein the thickness difference in the width direction of the film, except the knurled portion, is at least 5 μm, and a thickness at the knurled portion is 3-15 μm.

According to Patent Literature 2, generation of knicks and weaving (being winding slippage) due to poor roll formation (meaning generation of black band and depression) can be prevented when a cellulose triacetate film, which is suitable for such a protective layer of a polarizing plate, is wound on a core.

### SUMMARY OF THE INVENTION

### Problems to be Solved by the Present Invention

“Knurling” means a processing to form an embossed pattern of knobs at the edge portions of a film by feeding the edge portions of a cellulose ester film between matted pattern rollers, and to make the side edge portions of the film essentially thicker via knobs formed by knurling process, which results in more stabile winding of the film.

As described above, in Patent Literature 1, defined are knurling knobs of 3-25 μm and difference between the left and right edges of the film to be not more than 5 μm, and in Patent Literature 2, defined as lateral film thickness deviation of not more than 5 μm and knurling knobs of 3-15 μm.

However, since a film roll may cause depression when knurling knobs are too high, while conversely there may be apparent no desired effects when the knurling knobs are low too, it has been difficult to provide suitable knurling to not cause knicks defects on a film.

An object of this invention is to overcome the problems of conventional techniques described above and to provide a method of manufacturing of a resin film in which reduction of installation costs and assurance of required physical properties of resin films can be achieved, as well as defects such as blocking in the center of a roll of film are hardly ever caused, even during storage of a wide roll of film under high temperature and high humidity, with respect to the method of manufacturing of a cellulose ester or a norbornene type resin film which has been prepared via a solution casting method or a melt casting method. Another object of this invention is to provide a polarizing plate, which is prepared by utilizing the resin film and which exhibits excellent quality, and further a liquid crystal display device, which is prepared by utilizing the polarizing plate and which exhibits uniform display capability.

### Means to Solve the Problems

The inventors of this invention have found, as a result of extensive study to solve the problems of conventional techniques described above, that defects in the center of a roll such as blocking are hardly ever caused even during storage of a roll film under high temperature and high humidity by controlling knurling height deviation (or embossed deviation) with respect to the knurling portion provided by an embossing process on both edges of the resin film as described above, which results in realization of this invention.

To realize the object as described above, in a method of manufacturing a resin film described in this invention, after edge portions of a cellulose acetate or a norbornene type resin film, which is prepared by a solution casting method or a melt casting method, are slit to form a film base for a specific product width, and the edge portions of the film base are subjected to a knurling process, resulting in manufacture of a resin film having a final film thickness of 30-125 μm, a film thickness deviation at random points across lateral direction of 0.1-1.8 μm, and a creak value of 0.4-1.4, wherein the mean value of knurling knob height measured at 10 random points spaced at a minimum of 10 mm intervals in the longitudinal direction is 5-15 μm, the minimum value of measured knurling knob height is at least 1 μm, the maximum value of measured knurling knob height is at most 20 μm, and deviation of measured knurling knob height is 1-10 μm. The term “creak value” means “the coefficient of kinetic friction” which is determined when the surface of a substrate and the opposite side of a rolled substrate are in contact with each other, and both substrates are pulled in the reverse direction under a constant load at a constant rate.

In the method of manufacturing the resin film described above, the lateral product width of a resin film is preferably 1,340-1,980 mm.

Further, a polarizing plate, described earlier in this invention, is characterized in that the employed resin film, described above, is laminated on at least one surface of a polarizer.

Further, the liquid crystal display device described in this invention is characterized by being prepared utilizing the polarizing plate described above.

The invention described above is a method of manufacturing a resin film in which after edge portions of the resin film comprised of cellulose acetate or a norbornene type resin, which is prepared by a solution casting method or a melt casting method, are slit to a specific product width, the edge portions of the film base are subjected to a knurling process, resulting in manufacture of a resin film having a final film thickness of 30-125 μm, a film thickness deviation at random points of 0.1-1.8 μm, and a creak value of 0.4-1.4, wherein the mean value of a knurling knob height measured at 10 random points spaced at a minimum of 10 mm intervals in the longitudinal direction is 5-15 μm, the minimum value of measured knurling knob height is at least 1 μm, the maximum value of measured knurling knob height is at most 20 μm, and the deviation of measured knurling knob height is 1-10 μm; and the manufacturing method of a resin film according to this invention achieves the effect of enabling manufacture of a cellulose ester film or a norbornene type resin film which rarely causes defects at the center of a roll such as blocking even of a roll of film having a width as wide as 1,340-1,980 mm being stored, particularly under high temperature and high humidity, without a significant additional installation cost.

Further, the polarizing plate described in this invention is characterized in that the resin film described above is laminated on at least one surface of a polarizing plate; and the polarizing plate of this invention achieves the desired effect of providing excellent characteristics in optical, physical and dimensional properties, and the excellent quality.

Further, the liquid crystal display device described in this invention is characterized by being prepared by utilizing the polarizing plate described above; and a liquid crystal display device according to this invention achieves the desired effect of providing a uniform display capability.

### DETAILED DESCRIPTION OF THE INVENTION

In the following paragraphs, this invention will be specifically described.

In the method of manufacturing a resin film according to this invention, after edge portions of a resin film comprised of cellulose acetate or a norbornene type resin, which is prepared by a solution casting method or a melt casting method, are slit to form a film of a specific product width, the edge portions of the film base are subjected to a knurling process, resulting in manufacture of a resin film having a final film thickness of 30-125 μm, a film thickness deviation across the width of 0.1-1.8 μm, and a creak value of 0.4-1.4.

Herein, when the film thickness deviation at arbitrary points across the width of a cellulose ester or a norbornene type resin film manufactured by the method of this invention is over 1.8 μm, it is not preferable that blocking will occur at portions having a large film thickness deviation across the width even under a uniform knurling condition. Wherein, the film thickness deviation across the width of at least 0.1 μm is necessarily generated in a resin film manufactured by a solution casting method or a melt casting method. Further, rarely generated are defects in the center of a roll even without controlling the knurling knob height when the creak value of a cellulose ester or a norbornene type resin film is less than 0.4. It is not preferred that blocking is often generated even with controlled knurling when the creak value is over 1.4.

Further, in the manufacturing method of this invention, the mean value of knurling knob height, measured at 10 random points spaced at least at 10 mm intervals in the conveyance direction of a cellulose ester or a norbornene type resin film is 5-15 μm, the minimum value of measured knurling knob height is at least 1 μm, the maximum value of measured knurling knob height is at most 20 μm, and the deviation of measured knurling knob height is 1-10 μm.

Herein, it is not preferred that blocking or deformation is generated at the center of a roll when the mean knurling knob height is less than 5 μm. Further, it is not preferred that roll deformation due to aging will be generated to produce blocking when the mean knurling knob height is over 15 μm.

Further, when the minimum value of measured knurling knob height is less than 1 μm, blocking will be generated, contrary to the case of lower knurling. While, when the maximum value of measured knurling knob height is over 20 μm, it is not preferable that deformation of a roll due to aging becomes significant.

Further, in the method of this invention, when a knurling deviation is less than 1 μm, blocking may be generated in the case of lower knurling. On the contrary, when knurling knob deviation is over 10 μm, it is not preferable that partial blocking or deformation of a roll will be generated.

Herein, the product of a cellulose ester or a norbornene type resin film manufactured with the method of this invention is generally provided at film width of 1,340-1,980 mm. It is not preferred that the factor of film thickness deviation becomes more significant than the desired effects of knurling, when film width is less than 1,340 mm. While, it is not preferred that desired knurling effects are hardly ever exhibited resulting in blocking generation under any condition when the film width is over 1,980 mm.

In a method of this invention, cellulose esters utilized as a raw material for film include cellulose triacetate, cellulose diacetate, cellulose acetate butyrate and cellulose propionate. In the case of cellulose triacetate, in particular, cellulose triacetate provided with a polymerization degree of 250-400 and a bonding acetic acid amount of 54-62.5% is preferable, but more preferable is a bonding acetic acid amount of 58-62.5%, with respect to base strength. Cellulose triacetate can be employed alone or in combinations of either cellulose triacetate synthesized from cotton fiber linters and/or cellulose triacetate synthesized from wood pulp.

It is preferable to employ more cellulose triacetate synthesized from cotton fiber linters exhibiting excellent peelability from, for example, a belt or a drum because of higher production efficiency. Since the effect of peelability becomes significant at a ratio of cellulose triacetate synthesized from cotton fiber linter of not less than 60 weight %, not less than 60 weight % but more preferably not less than 85 weight % is preferred, however most preferable is to employ only cotton fiber linters.

On the other hand, in a manufacturing method of this invention, a norbornene type resin, which is a primary raw material of a norbornene type resin film, are commonly known resins, described in such as JP-A Nos. 3-14882 and 3-112137.

Monomers to constitute a norbornene type resin film include, for example, norbornene, 5-methyl-2-norbornene, 5-ethyl-2-norbornene, 5-butyl-2-norbornene, 5-ethylidene-2-norbornene, 5-methoxycarbonyl-2-norbornene, 5,5-dimethyl-2-norbornene, 5-cyano-2-norbornene, 5-methyl-5-methoxycarbonyl-2-norbornene, 5-phenyl-2-norbornene and 5-phenyl-5-methylnorbornene.

A norbornene type resin includes, for example, (A) resin in which an open ring polymer of a norbornene type monomer or a hydrogenated resin thereof after having been appropriately modified by such as maleic acid addition or cyclopentadiene addition, (B) resin in which a norbornene type monomer is addition polymerized, (C) resin in which a norbornene type monomer is addition polymerized with an olefin type monomer such as ethylene and α-olefin, (D) resin in which a norbornene type monomer is addition polymerized with a cyloolefin type monomer such as cyclopentene, cyclooctene and 5,6-dihydrodicyclopentadiene, and modified products of these resins; and this polymerization can be performed by a conventional method.

In the method of manufacturing a resin film of this invention, employable plasticizers are not specifically limited, however, preferably employed alone or in combination, are: for example, a phosphoric acid ester, such as triphenylphosphate, tricresylphosphate, cresyldiphenylphosphate, octyldiphenylphosphate, diphenylbiphenylphosphate, trioctylphosphate and tributylphosphate; a phthalic acid ester, such as diethylphthalate, dimethoxyethylphthalate, dimethylphthalate, dioctylphthalate, dibutylphthalate and di-2-ethylhexylphthalate; and a glycol ester, such as triacetylene, tributyrin, butylphthalyl butylglycolate, ethylphthalyl ethylglycolate, methylphthalyl ethylglycolate and butylphthalyl butylglycolate.

Plasticizers may be appropriately employed in combination of at least two types, and in this case, the usage ratio of a plasticizer of a phosphoric acid type ester is preferably not more than 50% because hydrolysis of a cellulose ester or a norbornene type resin is barely induced, resulting in excellent durability.

It is further preferable that the ratio of a plasticizer of a phosphoric acid type ester is lower, and specifically preferable is to employ only plasticizers of a phthalic acid type ester and a glycol acid type ester.

In this invention, further, to make the water absorptive ratio and the moisture regain in predetermined ranges, preferable addition amount of a plasticizer is 3-30 weight %, more preferably 10-25 weight %, but still more preferably 15-25 weight %. When it is over 30 weight %, mechanical strength and dimensional stability are deteriorated.

In the method of manufacturing a resin film of this invention, as employable UV absorbing agents, preferable are those provided with excellent absorbability of UV rays of a wavelength of not more than 380 nm with respect to avoiding deterioration of liquid crystals and a polarizer, as well as with as little absorption as possible of visible light of a wavelength not less than 400 nm with respect to liquid crystal display capability. In particular, transparency at a wavelength of 380 nm is necessary to not be more than 10%, preferably not more than 5% but most preferably not more than 2%.

UV absorbing agents generally employed include, for example, oxybenzophenone type compounds, benzotriazole type compounds, salicylic acid ester type compounds, benzophenone type compounds, cyanoaclylate type compounds and nickel complex salt type compounds, but are not limited thereto.

In this invention, at least one type of these UV absorbing agents is preferably employed, and at least two types of different UV absorbing agents may also be incorporated.

In this invention, preferably utilized UV absorbing agents are such as benzotriazole type UV absorbing agents and benzophenone type UV absorbing agents. An embodiment, in which a benzotriazole type UV absorbing agent is added in a cellulose ester or a norbornene type resin film, is specifically preferred because of further reduced undesirable coloring.

Other than these, as UV absorbing agents, preferably utilized may be triazine type UV absorbing agents or polymer UV absorbing agents described in JP-A Nos. 2001-154017 and 6-130226, which have been proposed before by the present applicant.

In this invention, as an addition method of a UV absorbing agent, a UV absorbing agent is added into a cellulose ester or a norbornene type resin solution after having been dissolved with other additives and cellulose ester, or a norbornene type resin in an organic solvent such as alcohol, methylene chloride and dioxane. An inorganic powder, which is not soluble in an organic solvent, is added into a cellulose ester or a norbornene type resin solution after having been dispersed with an organic solvent in cellulose ester or a norbornene type resins by use of a desolver or a sand mill.

The used amount of a UV absorbing agent in this invention is traditionally 0.1-2.5 weight %, preferably 0.5-2.0 weight % but more preferably 0.8-2.0 weight %, based on weight % of cellulose ester or a norbornene type resin. It is not preferable for a tendency of deteriorating transparency when the used amount of a UV absorbing agent is at least 2.5 weight %.

In this invention, as a solvent for cellulose ester, utilized may be, for example, lower alcohols such as methanol, ethanol, n-propyl alcohol, iso-propyl alcohol and n-buthanol; cyclohexane dioxanes; and lower aliphatic hydrocarbon chlorides such as methylene chloride.

As a solvent ratio, for example, a ratio of 70-95 weight % of methylene chloride to 30-5 weight % of other solvents is preferable. Further, a concentration of cellulose ester is preferably 10-50 weight %. Heating temperature at addition of a solvent is preferably not lower than the boiling point of the used solvent and in a temperature range below the boiling point of the solvent, and is preferably set to, for example, at least 60° C. and in a range of 80-110° C. Further, pressure is adjusted not to boil the solvent at the set temperature.

In this invention, solvents for a norbornene type resin include high boiling point solvents such as toluene, xylene, ethylbenzene, chlorobenzene, trimethylbenzene, diethylbenzene and isopropylbenzene, preferable of which are toluene, xylene and chlorobenzene. Further, utilized may be mixed solvents of these high boiling point solvents with a low boiling point solvent such as cyclohexane, benzene, tetrahydrofuran, hexane or octane.

Further, as a solvent for norbornene type resin, utilized may be methylene chloride alone, or methylene chloride mixed with the above listed solvents.

For example, after cellulose ester or a norbornene type resin has been dissolved in a pressurized vessel, the solution is removed from the vessel while being cooled or drawn out of the vessel by, for example a pump to be cooled with such as a heat exchanger, and is then subjected to casting.

The type of pressurized vessel is not specifically limited provided it is capable of withstanding a predetermined pressure and of being capable of heating and stirring. In addition, the pressurized vessel is preferably equipped with measurement devices such as a manometer and thermometer. Pressure may be applied by a method of introducing an inert gas, such as a nitrogen gas, under pressure, or by means of increasing the vapor pressure of a solvent with heating. Heating is preferably performed from the exterior, and as an example, a jacket type vessel is preferred due to ease of temperature control.

Heating temperature during addition of a solvent is preferably of at least the boiling point of the employed solvent and in a temperature range to not boil the solvent, and is preferably set to, for example, at least 60° C. and in a range of 80-110° C. Further, pressure is set to not allow the solvent to boil at the set temperature.

After dissolution of resin, the solution is removed from the vessel while being cooled via a heat exchanger or drawn from the vessel via such as a pump and cooled, and is then supplied for casting. At this time, the cooling temperature may be ordinary ambient temperature, however, it is preferable to cool the solution to at most no higher than the boiling point by 5-10° C., casting is to be performed at the same temperature because viscosity of the dope is maintained low.

Further, in this invention, micro-particles as a matting agent are added to a cellulose ester film or a norbornene type resin film. Herein, the type of s may be either an inorganic or organic compound, and an inorganic compound includes micro-particles such as silicon dioxide, titanium dioxide, aluminum oxide, zirconium oxide and tin oxide, of which compounds containing silicon atoms are preferred, and specifically preferred are silicon dioxide micro-particles.

Such silicon dioxide micro-particles include, for example, Aerosil-200, -200V, -300, -R972, -R972V, -R974, -R202, -R812, -R805, -OX50 and -TT600, manufactured by Aerosil Co., Ltd., of which Aerosil-200V and -R972 are preferred with respect to control of factors such as dispersibility and particle size.

In this invention, the addition amount of micro-particles described above is typically 0.05-0.5 weight %, preferably 0.10-0.35 weight % but more preferably 0.20-0.30 weight %, in regard to the weight of the film.

In the production method of this invention, for example, after the micro-particles as described above have been dispersed in a solvent containing 25-100 weight % of a water soluble solvent, the micro-particle dispersion is diluted by adding 0.5-1.5 times an organic solvent compared to the water soluble solvent. Successively, this micro-particle dispersion is mixed with a cellulose ester solution, into which cellulose ester has previously been dissolved.

As the water soluble solvent described above, primarily employed is a lower alcohol, which preferably includes methyl alcohol, ethyl alcohol, propyl alcohol, iso-propyl alcohol or butyl alcohol.

Further, the non-water soluble solvent is not specifically limited, however, solvents employed at the time of casting of cellulose ester are preferred, and preferably employed are those having a solubility in water of not more than 30 weight %, including such as methylene chloride, chloroform and methyl acetate.

Herein, micro-particles are dispersed at a concentration of 1-30 weight % in a solvent. It is not preferable when dispersion to perform at a higher concentration than this, because of a steep increase of viscosity. The concentration of micro-particles in a dispersion solution is preferably 5-25 weight % but more preferably 10-20 weight %.

In this invention, in the case of manufacturing a cellulose ester or a norbornene type resin film via a solution casting method, a dope of a cellulose ester or a norbornene type resin film is prepared by mixing, for example a cellulose ester or a norbornene type resin, a UV absorbing agent, additives such as micro-particles and solvents in a dissolution vessel. Successively, this dope of a cellulose ester or a norbornene type resin film is flowed onto a support by a casting die of a solution casting apparatus (being a casting process), the cast film peeled from the support after a portion of the solvents have been removed via heating (being drying process of the support), and the peeled film is dried (being a film drying process) resulting in preparation of a cellulose ester or a norbornene type resin film.

As a support in the casting process, employed is a support comprising mirror-surface finished stainless steel as a looped belt form or a drum form. With respect to temperature of the support in the casting process, casting is possible at typical temperature range, being zero to the boiling point of the solvent, however, casting is preferably performed on a support at a temperature of 5-30° C. but more preferably at 5-15° C. to reduce the limited time to cause the dope to gel and be peelable. The peel limit time means the duration while the cast dope is on a support at a limited casting speed at which the film resulting in excellent transparency and flatness can be continuously produced. The shorter the peel limit time is, the better the productivity, which is of course preferred.

During the drying process on a support, after the dope is cast and once it is gelled, it is preferable to bring the dope temperature to 40-70° C. within 30% from casting, when time from casting to peeling is 100%, with respect to accelerating evaporation of the solvent to enable faster peeling from the support as well as increasing the peeled film strength, but it is more preferable to bring the dope temperature to 55-70° C. within 30% from casting. This temperature is preferably maintained for at least 20% but more preferably for at least 40%.

In drying on the support, the film dope is preferably peeled from the support at a residual solvent amount of 60-150% but more preferably of 80-120%, with respect to decreased peeling resistance from the support. The dope temperature at the time of peeling is preferably 0-30° C. but more preferably 5-20° C., with respect to increasing the base strength at peeling, and preventing breaking of the base during peeling.

The residual solvent amount of the film is represented by the following equation.
Residual solvent amount=(residual volatile component weight/film weight after heat treatment)×100 (%)

Wherein, the residual volatile component weight is the value of film weight before heat treatment minus film weight after heat treatment, when the film is heated at 115° C. for 1 hour.

In the film drying process, it is preferable that the film, having been peeled from the support, is further dried to bring the residual solvent amount to at least 3 weight %, preferably at least 1 weight % but more preferably at least 0.5 weight %, with respect to preparing the film possessing excellent dimensional stability. In the film drying process, applied is a method to dry the film while transported via a hanging roll method, a pin tenter method or a clip tenter method. As materials for a liquid crystal display application, film is preferably dried while the width is maintained via a tenter method, which tends to improve dimensional stability. It is specifically preferable to maintain the width when the residual solvent amount is large immediately after the film is peeled from the support to enhance the effect of improved dimensional stability.

In particular, in the drying process after peeling from the support, the film tends to shrink in the lateral direction due to evaporation of solvents. The higher the drying temperature, the larger the shrinkage becomes. It is preferable during drying to depress this shrinkage as much as possible with respect to preparing a finished film exhibiting excellent flatness. In this view, for example as described in JP-A 62-46625, preferable is a tenter method to dry a web of film while it is held at both edges by clips during all or part of the drying process.

The drying means to dry of the film is not specifically limited, and is generally performed by such as hot air flow, infrared rays, heated rollers and microwaves, of which preferred is hot wind flow with respect to overall simplicity. The drying temperature is preferably raised gradually within the range of 40-150° C. being divided into 3-5 steps but more preferably within the range of 80-140° C., with respect to improving dimensional stability.

These processes, from casting to post drying, may be performed under an air atmosphere or an inert gas atmosphere such as nitrogen. Herein, in the case of an air atmosphere, the drying atmosphere is naturally set in consideration of limiting the concentration of flammability of the solvents.

Next, to be described in this invention, the case of manufacturing a resin film comprising cellulose ester or a norbornene type resin via a melt casting method.

In this invention, “melt casting” means that cellulose ester or a norbornene type resin is thermally melted until exhibiting fluidity without employing a solvent, thereafter the fluid cellulose ester or norbornene type resin is extruding casted on a looped belt or drum.

Cellulose ester or a norbornene type resin, which may contain various types of additives employed in melt casting, contains negligible amounts of volatile solvent; on the other hand, however, a solvent may be employed in part of the processes to prepare the fused cellulose ester or norbornene type resin.

It is preferable to employ a film comprising a lower fatty acid ester of cellulose as a cellulose ester film to constitute a protective film. “A lower fatty acid in a lower fatty acid ester of cellulose” means a fatty acid having at most 6 carbon atoms, and a lower fatty acid ester preferably includes, for example, cellulose acetate, cellulose propionate and cellulose butyrate. In addition to these, employed may be mixed fatty acid esters such as cellulose acetate propionate and cellulose acetate butyrate. On the other hand, those described previously may be employed as a norbornene type resin.

In another method of this invention, the foregoing plasticizers, UV absorbing agents and matting agents may be incorporated in addition to cellulose ester or a norbornene type resin.

Further, in another embodiment, after cellulose ester or a norbornene type resin is dissolved at least once dissolved in a solvent, the cellulose ester or norbornene type resin, from which a solvent has been evaporated, is preferably employed. Preferably employed is a cellulose ester or norbornene type resin which has been dissolved in a solvent together with at least a plasticizer, a UV absorbing agent or a matting agent, followed by drying. Further, the resin is preferably cooled to at most −20° C. during the dissolution process. Such cellulose ester or norbornene type resin is preferably added because it easily causes each additive to be homogeneous when in a fused state, and is superior in exhibiting uniform optical characteristics. Particularly, preferably at least 1 weight %, more preferably at least 5 weight %, still more preferably at least 10 weight %, furthermore preferably at least 30 weight % and most preferably at least 50 weight %, of the total amount of cellulose ester or norbornene resin is added, but it is most preferable that all the cellulose ester or norbornene type resin raw materials are once dissolved in a solvent.

In another manufacturing method of the resin film of this invention, polymer components other than cellulose ester or a norbornene type resin may be suitably mixed. The polymer components to be mixed are preferably provided with excellent compatibility with cellulose ester, and have light transmittance of preferably at least 80%, more preferably at least 90% and furthermore preferably at least 92% of the cast film.

In the following method of manufacturing a resin film by means of a melt casting method of this invention will be further detailed, however, this invention is not limited thereto. Herein, the longitudinal direction refers to the casting direction (being the film length) and the lateral direction (being the film width) refers to be perpendicular to the casting direction of the film.

Initially, cellulose ester or norbornene type resin, as a raw material, is molded into pellet form to be subjected to forced hot air drying or vacuum drying, followed by extrusion through a T die into a sheet form, which is then brought into contact with a cooling drum to be solidified via an electrostatic discharge method or other suitable methods, resulting in preparation of an unstretched cast sheet. The temperature of the cooling drum is preferably maintained at 90-150° C.

In the case of preparing a protective film of a polarizing plate employing a resin film according to the method of this invention, the cellulose ester or norbornene type resin film is preferably a cast film by being stretched along the width direction or the casting direction.

An unstretched sheet, which is prepared by having been peeled from the foregoing cooling drum, is preferably stretched in one step or multiple-steps by being heated in the range of the glass transition temperature (Tg) of cellulose ester or norbornene type resin to Tg+100° C. via a heating device, such as a plural number of roller groups and/or an infrared ray heater.

Next, the longitudinally stretched cellulose ester or norbornene type resin film, which has been prepared in the above manner, is preferably stretched laterally in a temperature range of Tg−(Tg−20° C.) and then thermally fixed.

When a film is stretched laterally, such stretching is preferably performed in at least two divided stretching regions while successively increasing the temperature within a difference range of 1-50° C., to minimize distribution of the physical properties across the width. Further after lateral stretching, a film is preferably maintained in a range from at most the final lateral stretching temperature to at least Tg−40° C., for 0.01-5 minutes to further decrease distribution differences of the physical properties across the width.

Thermal fixing is performed within a temperature range of at least the final lateral stretching temperature to at most Tg−20° C. for generally 0.5-300 seconds. At this time, it is preferable to perform thermal fixing in at least two regions while successively increasing the temperature within a temperature difference of 1-100° C.

A thermally fixed film is cooled to generally at most the Tg, and wound up after the clipped portions of both edges of the film are trimmed. At that time, the film is preferably subjected to relaxation treatment of 0.1-10% in the lateral direction and/or the longitudinal direction in a temperature range from at most the final thermal fixing temperature to at least the Tg. Further, cooling is preferably performed as slow cooling from the thermal fixing temperature to the Tg at a cooling rate of at most 100° C. per second. The means for cooling and relaxation treatment is not specifically limited and conventionally common methods may be employed, however, these treatments are preferably performed specifically while successively cooling the film in plural temperature ranges with respect to improved dimensional stability of the film. Herein, the cooling rate is a value represented by (T1−Tg)/t, when the final thermal fixing temperature is T1 and t is the time required for the film to reach the Tg from the final thermal fixing temperature.

The more suitable conditions of these thermal fixing, cooling and relaxing treatment conditions, differ depending on the cellulose eater or norbornene type resin constituting the film, and will be determined by suitably measuring physical properties of the obtained biaxially stretched film and suitably adjusted to provide desirable characteristics.

In the case of preparing the protective film for the polarizing plate by employing the resin film according to the methods of this invention, the Tg of the cellulose ester or norbornene type resin film is preferably at least 150° C. and more preferably least 180° C. Tg is determined as a mean value of the temperature at which base line starts to rise and the temperature at which the curve returns to the base line. Further, the melting temperature is preferably in the range of 110-280° C. and more preferably at least 200° C.

With respect to the preferable stretching ratio of the cellulose ester or norbornene type resin film, the stretching ratio in one direction is 1.01-3.00 times and the stretching ratio in the other direction is 0.95-2.5 times, more preferably the stretching ratio in one direction is 1.01-3.00 times and the stretching ratio in the other direction is 0.95-1.5 times, still more preferably the stretching ratio in one direction is 1.01-2.50 times and the stretching ratio in the other direction is 0.95-1.25 times, but most preferably the stretching ratio in one direction is 1.01-2.00 times and the stretching ratio in the other direction is 0.95-1.10 times. Thereby, the cellulose ester or norbornene type resin film exhibiting excellent optical isotropy can be preferably prepared. These width maintenance and lateral stretching volume are preferably performed via a tenter mothod, either by a pin tenter or a clip tenter method.

In a resin film prepared with a melt casting method of this invention, the residual solvent amount contained in a cellulose ester or norbornene type resin film, which has been wound after casting, is stably less than 0.1 weight % because essentially no solvent is employed in a casting process. That is, specifically the retardation Rt value in the thickness direction remains stable to allow easier handling when the residual solvent amount is less than 0.1 weight %. In a protective film of a polarizing plate, minimum variation of the Rt is critical to obtain stable optical characteristics, and this invention assures a cellulose ester or norbornene type resin film exhibiting a stable retardation Rt in thickness.

A winder employed in the winding process of a cellulose ester or norbornene type resin film prepared via a solution casting method or a melt casting method may be any of these commonly employed, and the film can be wound by a winding method such as a constant tension method, a constant torque method, a taper tension method and a programmed tension method to control constant internal stress.

At this stage, to stabilize winding properties of cellulose ester or norbornene type resin film, a so-called knurling treatment, which provides roughness on both edges of the resin film to make the edges act as thicker portions, is performed.

Ratio X (%) of knurling knob height (a: μm) compared to film thickness (d: μm)

X is preferably in the range of 5′-25% to stabilize winding properties, when ratio X (%)=(a/d)×100, but is more preferably 5-15%. It is not likely that deformation of the wound roll caused when the knurling knob height ratio is greater than this, while winding properties deteriorate when knurling knob height ratio is less.

In this invention, thickness of the cellulose ester or norbornene type film is generally 20-200 μm, however, it is preferably 20-65 μm, more preferably 30-60 μm but still more preferably 35-50 μm, due to continual demand for a thinner and lighter polarizing plate, employed for LCDs. Often caused are problems due to such as wrinkles generated in a polarizing plate preparation process because stiffness of the film is reduced as a film becomes thinner than this, while desirable contribution to a thinner LCD is minimal when the film is thicker than this.

### EXAMPLES

In the following paragraphs, this invention will be specifically described based on examples, however, is not limited thereto.

### Example 1

Dope Composition 1

| | | |
|---|---|---|
| Cellulose triacetate | 100 | weight parts |
| Methylene chloride | 350 | weight parts |
| Ethanol | 12 | weight parts |
| Triphenylphosphate | 12 | weight parts |
| Tinuvin 326 (manufactured by Ciba Specialty | 0.5 | weight part |
| Chemicals, Inc.) | | |
| Silicon dioxide micro-particles (product name: | 0.1 | weight part |
| Aerosil-200V, manufactured by Nippon | | |
| Aerosil Corp.) | | |

These were charged into a shielded vessel and completely dissolved while maintained at 80° C. and stirred under pressure.
Preparation of Film Sample

A solution of above described Dope Composition 1, after having been filtered, was cast on a support constituted of a looped stainless steel belt via a die at a dope temperature of 33° C. by use of a solution casting apparatus (the drawing being omitted). The dope solution was dried, by leaving on the support for 60 seconds, until it became peelable, and then the web (being a dope film) was peeled from the support. At this stage, the residual solvent amount of the web was 25%. The time required from dope casting to peeling was 3 minutes. The web having been peeled from the support was dried in a drying zone while being transported by plural rollers, while both edges were simultaneously slit to form a film base to the predetermined product width. The edge portions of the film were then subjected to a knurling process, followed by being wound onto a core as a roll form, resulting in preparation of a cellulose triacetate (TAC) film sample having a final film thickness of 40 am, a film thickness deviation in at random points across the width of 0.5 μm and a creak value of 0.7. Herein, the film width was 1,385 mm, the wound length was 3,000 m, and casting rate was 30 m/min.

With respect to the obtained cellulose triacetate film, the mean value of measured knurling knob height at 10 random points in the longitudinal direction at intervals of at least 10 mm, the minimum value of measured knurling knob height, and the maximum value thereof were measured, as well as the deviation of measured knurling heights was calculated. The obtained results are shown in Table 1 in a following paragraph.

### Example 2

Preparation of Film Sample

A cellulose triacetate (TAC) film sample was prepared in a manner similar to Example 1 by employing above solution for Dope Composition 1. Herein, the film width was 1,385 mm, the final thickness of the prepared cellulose triacetate film was 80 μm, the film thickness deviation at random points across the width was 0.9 μm and the creak value was 0.8.

Then, with respect to the prepared film, the mean value of measured knurling knob height at 10 random points in the longitudinal direction at intervals of at least 10 mm, the minimum value of measured knurling knob height, and the maximum value thereof were measured, as well as the deviation of measured knurling knob height was calculated. These obtained results are shown in Table 1 in a following paragraph.

Dope Composition 2

| | | |
|---|---|---|
| Cellulose triacetate | 100 | weight parts |
| Methyl acetate | 450 | weight parts |
| Acetone | 50 | weight parts |
| Etylphthalyl ethylglycolate | 1 | weight part |
| Tinuvin 326 (manufactured by Ciba | 0.5 | weight part |
| Specialty Chemicals, Inc.) | | |
| Silicon dioxide micro-particles (product name: | 0.1 | weight part |
| Aerosil-200V, manufactured by Nippon | | |
| Aerosil Corp.) | | |

These were charged into a shielded vessel and completely dissolved while maintained at 80° C. and stirred under pressure.
Preparation of Film Sample

A cellulose triacetate (TAC) film sample was prepared in a manner similar to Example 1 by employing the above solution for Dope Composition 2, except that the film width was set to 1,360 mm. The cellulose triacetate (TAC) film sample having the final thickness of 80 μm, the film thickness deviation in at random points across the width of 0.9 μm and the creak value of 0.7 was prepared by winding the prepared cellulose triacetate film onto a core to form a roll.

Then, with respect to the prepared film, the mean value of measured knurling knob height at 10 random points in the longitudinal direction at intervals of at least 10 mm, the minimum value of measured knurling knob height, and the maximum value thereof were measured, as well as the deviation of measured knurling knob height was calculated. The obtained results are shown in Table 1 in a following paragraph.

### Example 4

Preparation of Film Sample

A cellulose triacetate (TAC) film sample was prepared in a manner similar to Example 1 by employing the above Dope Composition 2. Herein, the width of film was 1,360 mm, the final thickness of the prepared cellulose triacetate film was 58 μm, the thickness deviation in at random points across the width was 0.7 μm and the creak value was 0.8.

Then, with respect to the prepared film, the mean value of measured knurling knob height at 10 random points in the longitudinal direction at intervals of at least 10 mm, the minimum value of measured knurling knob height, and the maximum value thereof were measured, as well as the deviation of measured knurling knob height was calculated. These obtained results are shown in Table 1 in a following paragraph.

### Example 5

A norbornene type resin film was prepared in a manner similar to Examples 1-4 described above, except that as a transparent resin a norbornene type resin was employed instead of cellulose acetate.

Preparation of Mico-particle Dispersion

| | | |
|---|---|---|
| Ethanol | 27 | weight parts |
| Micro-particles/silicon dioxide micro-particles | 3 | weight parts |
| (product name: Aerosil-R972V, primary particle | | |
| diameter of 16 nm) | | |

The above materials were charged into a specified vessel to be mixed, and after having being stirred at 300 rpm for 30 minutes, the solution was homogenized via a high pressure homogenizer under a pressure of 250 kgf/cm², after which the dispersion was diluted with 27 weight parts of methylene chloride, resulting in preparation of Micro-particle Dispersion (a-2).

Preparation of Norbornene Type Resin Solution

| | | |
|---|---|---|
| Norbornene resin (Arton G, manufactured | 80 | weight parts |
| by JSR Co., Ltd.) | | |
| Etylphthalyl ethylglycolate | 2 | weight parts |
| (Plasticizer A) | | |
| Triphenyl phosphate (Plasticizer B) | 8 | weight parts |
| Methylene chloride | 250 | weight parts |
| (boiling point: 39.8° C.) | | |
| Ethanol | 10 | weight parts |

The above materials were charged into a dissolution vessel to be heated up to 70° C. and the norbornene resin was completely dissolved while stirring, resulting in preparation of a norbornene type resin solution. Herein, the time required for total dissolution was 4 hours. Next, the norbornene type resin solution was removed via an efflux tube, which was connected to the bottom of the vessel, followed by being fed via a liquid supply pump, and was subjected to filtration via a filtration device employing filter paper having an absolute filtering precision of 0.005 mm, at a filtering flow rate of 300 l/m²·hour and under a filtering pressure of 1.0×10⁶ Pa.

Preparation of Additive Solution

| | | |
|---|---|---|
| Above-described norbornene type | 75 | weight parts |
| resin solution | | |
| 2-(2′-hydroxy-3′,5′-di-t- | 25 | weight parts |
| butylphenyl)benzotriazole | | |
| (UV absorbing agent I) | | |
| Above-described Micro-particle | 60 | weight parts |
| Solution | | |
| Methylene chloride | 290 | weight parts |

In a dissolution vessel, after a part of the above-described norbornene type resin solution was added into methylen chloride while stirring, further added were a UV absorbing agent and the above-described Micro-particle Solution, in that order. After addition, the solution was heated to 40° C. and dissolved for 30 minutes, resulting in preparation of the above additive solution. Next, this additive solution was removed via an efflux tube, which was connected to the bottom of the vessel, followed by being pumped, and subjected to filtration via a filtration device employing filter paper having a nominal filtering precision of 20 μm.

Preparation of Dope for Norbornene Type Resin Film

Into the primary portion (being the residual portion) of the foregoing norbornene type resin solution, which had been filtered employing the above-described filtration device via filter paper having an absolute filtering precision of 0.005 mm, at a filtering flow rate of 300 l/m²·hour and under a filtering pressure of 1.0×10⁶ Pa, and pumped out via the efflux tube, the foregoing additive solution, which had been similarly filtered and pumped out via the integral efflux tube, was inline added; and the solutions were stirred by a static mixer resulting in preparation of a dope for anorbornrne type resin.

Preparation of Norbornene Type Resin Film Sample

The above dope for a norbornene type resin film was uniformly cast on a support constituted of a looped stainless steel belt via a casting die at a dope temperature of 35° C. employing a solution casting apparatus (the drawing being omitted). The dope was dried by remaining on a support for 60 seconds until it was peelable, and then the web (dope film) was peeled from the support, at which stage, the residual solvent amount of the web was 25%. The time required from dope casting to peeling was 3 minutes. The web, having been peeled from the support, was dried in a drying zone while being transported by plural rollers, while both edges were simultaneously slit to form a film base to the predetermined product width, and the edge portions of the film base were subjected to a knurling process, followed by being wound onto a core to form a roll, resulting in preparation of a norbornene type resin film sample having the final film thickness of 40 μm, the film thickness deviation in at random points across the width of 0.6 μm and the creak value of 0.7.

Herein, the film width was 1,386 mm, the wound length was 2,800 m, and casting rate was 32 m/min.

With respect to the obtained norbornene type resin film, the mean value of measured knurling knob height at random 10 points in the longitudinal direction at intervals of at least 10 mm, the minimum value of measured knurling knob height, and the maximum value thereof were measured, as well as the deviation of measured knurling knob height were calculated. The obtained results of which are also shown in Table 1 below.

### Example 6

Manufacture of Cellulose Acetate Film

A cellulose acetate film was obtained by employing cellulose acetate (CA-398-3, manufactured by Eastman Chemical Corp.) to form an 80 μm film via a melt casting method.

Herein, 0.6 weight % of epoxidized tall oil, 0.4 weight % of para-tert-butylphenol, 0.07 weight % of neopentylphenyl phosphate, 0.02 weight % of strontium naphthoate and 0.02 weight % of silicon dioxide micro-particles (Aerosil R972V), functioning as thermal stabilizers, were added to the film.

During preparation of the film, both edges of the film were slit while conveyed and formed to the predetermined product width, after which a knurling treatment was provided on both edges of the film base, followed by being wound on a core to form a roll, resulting in preparation of a cellulose acetate film sample having the final film thickness of 80 μm, the film thickness deviation in at random points across the width of 1.0 μm and the creak value of 0.8.

Herein, the film width was 1,360 mm, the wound length was 2,800 m, and casting rate was 25 m/min.

With respect to the obtained cellulose acetate film, the mean value of measured knurling knob height at 10 random points in the longitudinal direction at intervals of at least 10 mm, the minimum value of measured knurling knob height, and the maximum value thereof were measured, as well as the deviation of measured knurling knob height was calculated. Again the obtained results are shown in Table 1 in the following paragraph.

Comparative Sample 1

For comparison, a cellulose triacetate film was manufactured in a manner similar to above Example 1, except that the film width was set to 1,020 mm which is beyond the range of this invention. The prepared cellulose triacetate film was wound onto a core to form a roll of a cellulose triacetate (TAC) film sample having the final film thickness of 80 μm, the film thickness deviation in at random points across the width of 2.5 μm, which is also beyond the range of this invention, and the creak value of 1.5, which is again beyond the range of this invention.

With respect to the obtained cellulose acetate film, the mean value of measured knurling knob height at 10 random points in the longitudinal direction at intervals of at least 10 mm, the minimum value of measured knurling knob height, and the maximum value thereof were measured, as well as the deviation of measured knurling knob height was calculated. The obtained results are also shown in Table 1 below.

TABLE 1

| | | Example 1 | Example 2 | Example 3 | Example 4 | Example 5 | Example 6 | Comp. 1 |
|---|---|---|---|---|---|---|---|---|
| Dope composition | | 1 | 1 | 2 | 2 | 3 | 4 | 1 |
| Final thickness | | 40 | 80 | 80 | 58 | 40 | 80 | 80 |
| (μm) | | (A) | (A) | (A) | (A) | (A) | (A) | (A) |
| Thickness | | 0.5 | 0.9 | 0.9 | 0.7 | 0.6 | 1.0 | 2.5 |
| deviation (μm) | | (A) | (A) | (A) | (A) | (A) | (A) | (A) |
| Creak value | | 0.7 | 0.8 | 0.7 | 0.8 | 0.7 | 0.8 | 1.5 |
| | | (A) | (A) | (A) | (A) | (A) | (A) | (B) |
| Knurling | Mean | 9.5 | 10 | 10 | 9 | 9 | 11 | 15 |
| knob | (μm) | (A) | (A) | (A) | (A) | (A) | (A) | (A) |
| height | Minimum | 5 | 6 | 5 | 4 | 4 | 6 | 9 |
| | (μm) | (A) | (A) | (A) | (A) | (A) | (A) | (A) |
| | Maximum | 14 | 15 | 13 | 13 | 14 | 16 | 21 |
| | (μm) | (A) | (A) | (A) | (A) | (A) | (A) | (B) |
| | Deviation | 9 | 9 | 8 | 9 | 10 | 10 | 12 |
| | (μm) | (A) | (A) | (A) | (A) | (A) | (A) | (B) |

| | | | | | | | |
|---|---|---|---|---|---|---|---|
| Film width of | 1385 | 1385 | 1360 | 1360 | 1386 | 1360 | 1020 |
| product (mm) | (A) | (A) | (A) | (A) | (A) | (A) | (B) |

Note:
Comp.: Comparative Sample
A: Good
B: Not good

Evaluation of Resin Film

Next, above resin films of Examples 1-6 of this invention and Comparative Sample 1 were stored under a high temperature/high humidity (38° C./75%) atmosphere for approximately 2 weeks, followed by being subjected to evaluation for defects in the central portion in the length of the roll, to measure whether a defect of a horseback form, with respect to film appearance, was generated or not, whether blocking at a diameter of at least 5 mm was generated in the entire length of the roll, and further whether a minute deformation in the entire length of the roll was generated, the results of which are shown in following Table 2.

TABLE 2

| | | | Deformation |
|---|---|---|---|
| | | Blocking defect | defect |
| | Appearance | in the roll | in the roll |
| Example 1 | Few horseback | No blocking | No microscopic |
| | form defects | defects at | deformation |
| | (A) | a diameter of | defects (A) |
| | | at least 5 mm | |
| | | (A) | |
| Example 2 | Few horseback | No blocking | No microscopic |
| | form defects | defects at | deformation |
| | (A) | a diameter of | defects (A) |
| | | at least 5 mm | |
| | | (A) | |
| Example 3 | Few horseback | No blocking | No microscopic |
| | form defects | defects at | deformation |
| | (A) | a diameter of | defects (A) |
| | | at least 5 mm | |
| | | (A) | |
| Example 4 | Few horseback | No blocking | No microscopic |
| | form defects | defects at | deformation |
| | (A) | a diameter of | defects (A) |
| | | at least 5 mm | |
| | | (A) | |
| Example 5 | Few horseback | No blocking | No minute |
| | form defects | defects having | deformation |
| | (A) | a diameter not | defects (A) |
| | | less than 5 mm | |
| | | (A) | |
| Example 6 | Few horseback | No blocking | No microscopic |
| | form defects | defects at | deformation |
| | (A) | a diameter of | defects (A) |
| | | at least 5 mm | |
| | | (A) | |
| Comparison | Some horseback | At least 10 | At least 10 |
| 1 | form defects | blocking defects | microscopic |
| | collapsing at | at a diameter | deformation |
| | least 5 mm | of at least 10 mm | defects (B) |
| | (B) | (B) | |

It is clear from above table 2 that in any one of examples 1-6 of this invention, caused were few horseback-form defects in film appearance, no blocking defects at a diameter of at least 5 mm in the center portion in the length of the roll, nor microscopic deformation defects in the center portion in the length of the roll.

To the contrary, with respect to the resin film of Comparative Sample 1, some horseback-form depression of at least 5 mm were generated, and at least 10 blocking at a diameter of at least 10 mm in addition to at least 10 microscopic deformation defects were generated, resulting in Comparative Sample 1 being unacceptable as a protective film for a polarizing plate.

1. A method of manufacturing a resin film, comprising the steps of:
a) slitting a resin base at both edge portions, the resin-base comprising cellulose acetate or a norbornene type resin and being prepared with a solution casting method or a melt casting method so as to form a resin base to a predetermined product width; and
b) providing a knurling process on both edges of the slitted resin base, resulting in a final film thickness of 30 to 125 μm, a film thickness deviation in at random points across the width of 0.1 to 1.8 μm, and a creak value of 0.4 to 1.4:
wherein a mean value of knurling knob height measured at 10 random points in a longitudinal direction at intervals of at least 10 mm is 5 to 15 μm, a minimum value of measured knurling knob height is not less than 1 μm, a maximum value of measured knurling knob height is not more than 20 μm, and a deviation of the measured knurling knob height is 1 to 10 μm.

2. The method of manufacturing the resin film of claim 1, wherein a product width of the resin film is 1,340 to 1,980 mm.

3. A polarizing plate comprising a polarizer which is laminated on at least one surface with the resin film of claim 1.

4. A liquid crystal display device comprising the polarizing plate of claim 3.
